(19) United States
(12) Patent Application Publication
(10) Pub. No.: US 2025/0389453 A1
(43) Pub. Date: Dec. 25, 2025

(54) SOLAR WARMING APPARATUS

(71) Applicant: Emory Marcus SMITH, Mobile, AL (US)

(72) Inventor: Emory Marcus SMITH, Mobile, AL (US)

(21) Appl. No.: 19/242,280

(22) Filed: Jun. 18, 2025

Related U.S. Application Data
(60) Provisional application No. 63/663,837, filed on Jun. 25, 2024.

(51) Int. Cl. F24S 20/20; F24S 23/30; F24S 30/425; F24S 70/12

(52) U.S. Cl. CPC F24S 20/20; F24S 23/30; F24S 30/425; F24S 70/12; F24S 2020/23

(57) ABSTRACT

A solar warming apparatus includes a container with a heating band, a box that houses the container, and a lens supported by the box to focus light rays onto the heating band. The heating band conducts heat to the container's contents, while the top and bottom parts of the container are thermally insulating. In some embodiments, the lens is a Fresnel lens, and the container is rotatable via one or more rollers driven by various mechanisms, including motors or manual cranks. The system may incorporate optical focusing, safety features, and interchangeable or dual-chamber container designs to accommodate a variety of heating applications using sunlight.

### CROSS-REFERENCE TO RELATED APPLICATIONS

This application claims the benefit of U.S. Provisional Patent Application No. 63/663,837, filed on Jun. 25, 2024, the entirety of which is incorporated herein by reference.

### BACKGROUND

People who want to warm up things like food, beverages, baby milk, and water for washing (“substances to be heated” or “substances” hereafter) usually turn to powered appliances like microwave ovens, toaster ovens, electric or gas ranges, induction cookers, or grills that use charcoal, wood pellets, or propane. Campers usually make fires, use chemical heat tablets, light tea candles, or light camping stoves that run on propane, kerosene, or alcohol. Some people, however, may not have ready access to such electrical or chemical means to heat substances.

Where solar energy is available, the solar warming apparatus described below can make heating substances safe and convenient.

### BRIEF DESCRIPTION OF THE DRAWINGS

The drawings are included to provide a better understanding of the description below and constitute a part of this specification. The drawings illustrate example implementations of the disclosure and, with the description, explain the principles of the disclosure.

FIG. 1 shows an embodiment of a container according to one aspect of a solar warming apparatus.

FIG. 2 displays the container of FIG. 1 on a pair of rollers.

FIG. 3 shows how the rollers from FIG. 2 and the container from FIG. 1 might fit inside a box that has a lens for a lid.

FIG. 4 shows the assembled box and lid from FIG. 3 and, inside, the capsule resting on the rollers.

FIG. 5 illustrates, from a top-down view, how the lens focuses sunbeams, that land on top of it, onto a small part of the surface of the capsule underneath.

FIG. 6 shows another embodiment with a box, rollers, container, and lens.

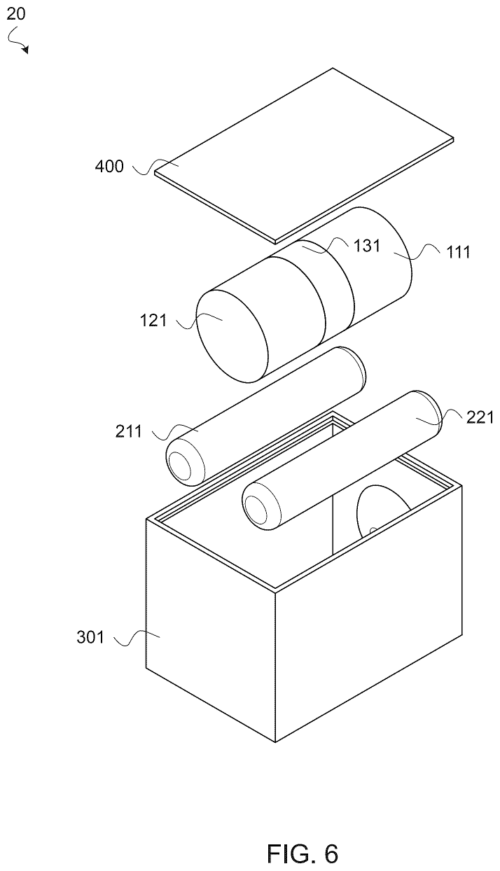

FIG. 7 shows the inside of the box of FIG. 6 and the rollers in position to receive the container.

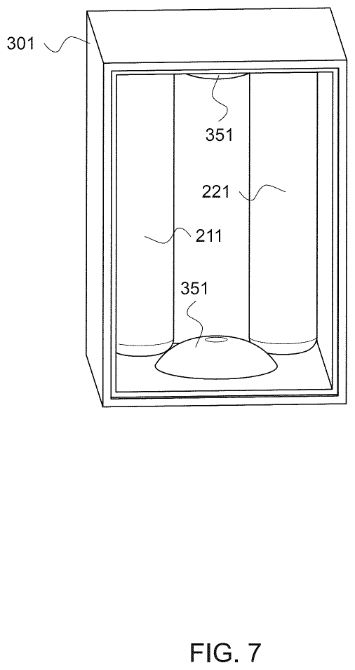

FIG. 8 adds the container on top of the arrangement shown in FIG. 7.

FIG. 9 shows the container separated into three parts.

FIG. 10 shows the three parts of the container, but in different positions.

FIG. 11 shows two of the three parts put together, standing next to the third part.

FIG. 12 shows how the container rests on the rollers, from a front oblique view.

FIG. 13 shows the same as in FIG. 12, but from a front-on view.

FIG. 14 shows the same as in FIG. 13, but from a side-on view.

FIG. 15 shows, from a side view, how the lens focuses sunbeams, that land on top of it, onto a small part of the surface of the capsule underneath.

### DETAILED DESCRIPTION

This section teaches the concepts of the invention through various examples. The extent of legal protection for the invention should be viewed in the light of the appended claims.

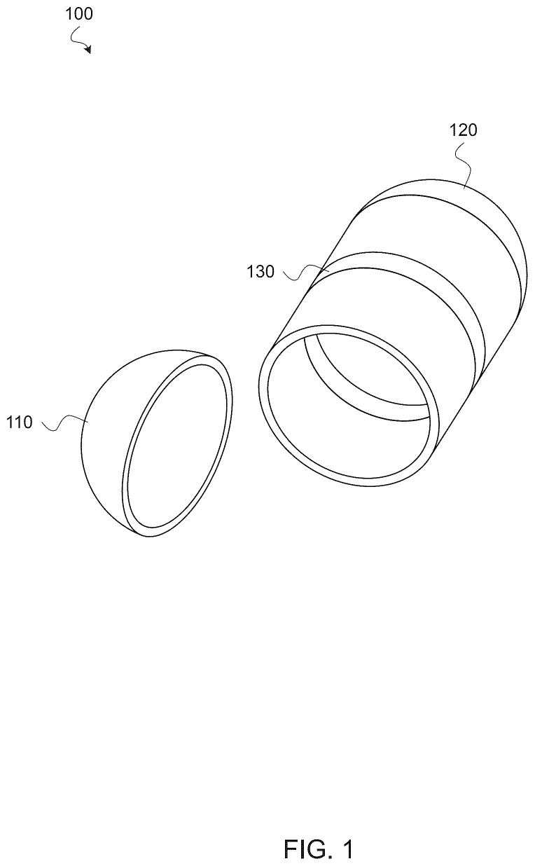

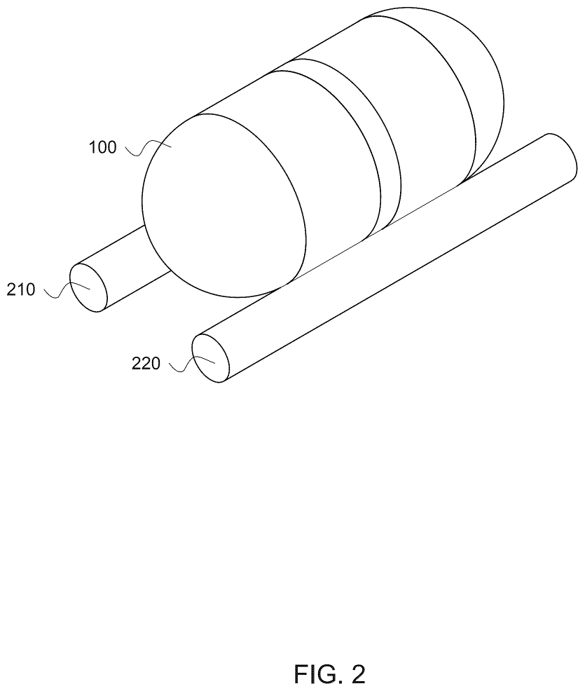

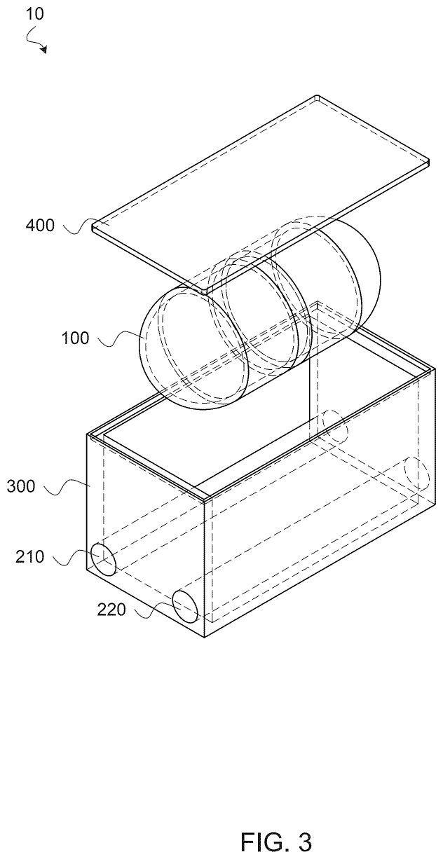

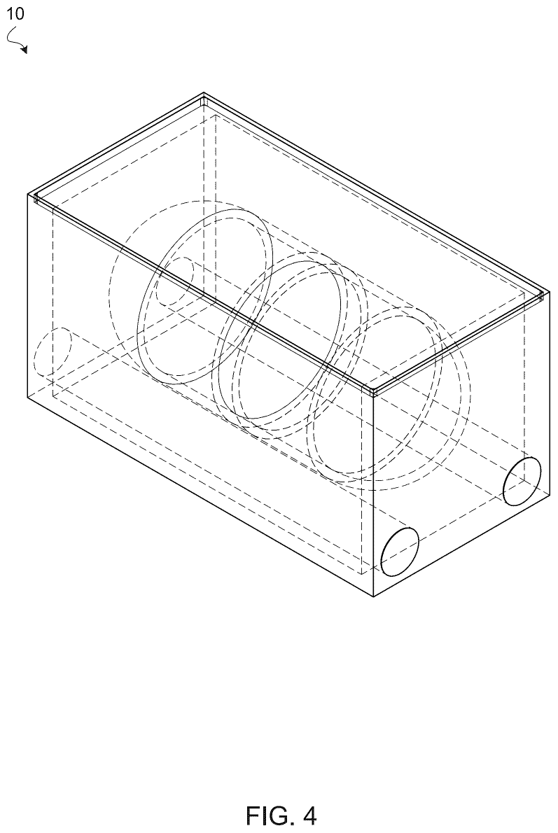

Referring to FIGS. 1-5, a first example 10 of a solar warming apparatus provides a capsule-shaped container 100. The container is made of a bottom part 110, a top part 120, and a heating band 130. The heating band is made up of a material that is a thermally conductive material, good at transferring heat, such as aluminum. The top and bottom parts are made of materials that are good at keeping heat in, such as double-wall stainless steel or ceramic. To put it another way, the heating band is a thermal conductor; the top and bottom parts are insulators.

The container in this example rests upon rollers 210 and 220. The rollers support the container in this example (i.e., the container is supported by rollers). When the rollers turn, the container turns. A motor may turn one or both rollers. There are many ways to make it so the container turns. In one example, a motor turns the container via a shaft. In another example, the motor turns the container via a belt. In yet another example, part of the container has teeth on the outside (i.e., external teeth) that engage teeth on one of the rollers (i.e., matching teeth) which makes it easier to control how the container turns. All of these examples of how to make the container turn may be thought of as means for rotating. There are many equivalents that could be used instead, including using suitably-placed magnets to turn the container, using a hand crank, or even using a suitable solar-powered electrical motor (i.e., the motor is supplied with energy from a solar energy supply system such as a solar panel and appropriate circuitry). The means for rotating may rotate the container directly or may rotate the container indirectly by powering at least one or perhaps more than one of the rollers.

In the embodiment where the container is rotated using a motor powered by a solar energy supply system, the apparatus may include a photovoltaic panel mounted on or near the box, a charge controller, and a small rechargeable battery or capacitor that stores electrical energy. The stored energy is supplied to a low-voltage motor that drives at least one of the rollers, either directly or through a gear system, or drives the container itself. For instance, a 6V DC motor may be powered by a solar panel with an output capacity of 6-12 volts under direct sunlight. The motor may be activated by a switch, timer, or electronic controller. In some configurations, the solar panel and motor are electrically connected using wires routed through the housing, and the motor is placed in a compartment protected from the elements.

The drawings do not show any particular means for rotating.

The rollers sit in a box which, in this example, is a housing 300. The box helps protect the user of the solar heating apparatus from coming in contact with parts that may get very hot and also from putting their fingers or other things in amongst the moving parts. The housing can be any sturdy material. In one embodiment, the box is made of plexiglass that has a film to reduce the glare from light reflecting from the heating band.

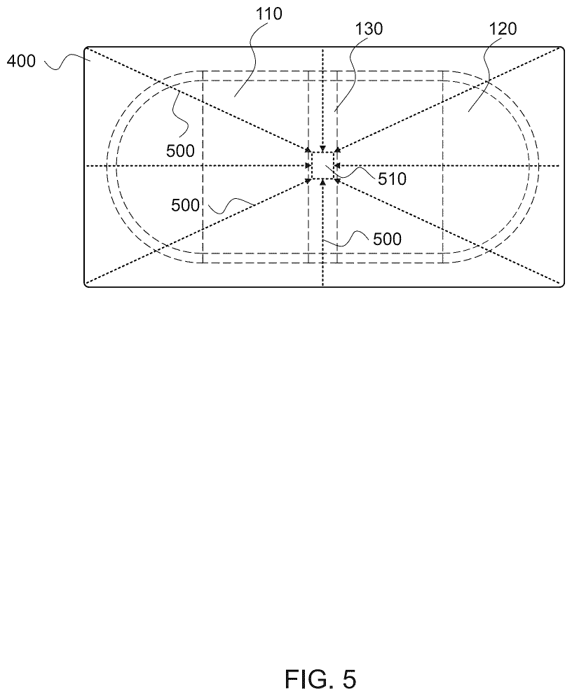

Above the box is a lens 400. In this example, the lens is a Fresnel lens that focuses light on a small part of the heating band 130. In FIG. 5, rays of light 500 come in from a direction above the lens and are focused on target area 510 which is on the surface of heating band 130.

In operation, the user puts the substance to be heated inside the container and closes the container. The user opens the lid of the box which is the lens. The user places the container on the rollers and closes the lid. The user puts the means for rotating into action by activating a switch, turning a crank, or even by interfacing with a mobile application (“app”) that remotely controls the action. The container rotates while the light rays heat the heating band. The heating band transfers its heat to the inside of the container and heats the substance inside.

In the embodiment where the user may activate or control the means for rotating the container via an app, the app may communicate with a controller embedded in the housing using a wireless protocol such as Bluetooth or Wi-Fi. The controller may include a microcontroller connected to a motor driver circuit. The app interface may allow the user to start or stop the rotation, adjust rotation speed, or set a timer for how long the container should rotate. In one example, the motor is a 6V DC motor controlled by pulse-width modulation (PWM) signals from the microcontroller, and the app sends commands that are received via a Bluetooth module, such as an HC-05, embedded in the housing.

The width of the heating band should be set in consideration of the focusing ability of the lens. To make the transmission of heat to the substance efficient, the width of the heating band should be about the same as the focal area width, namely, the width of target area 510 where the focus meets the container.

The rest of the figures show a second example 20 of a solar warming apparatus that is similar to the first example 10, except that the container and the box are shaped differently.

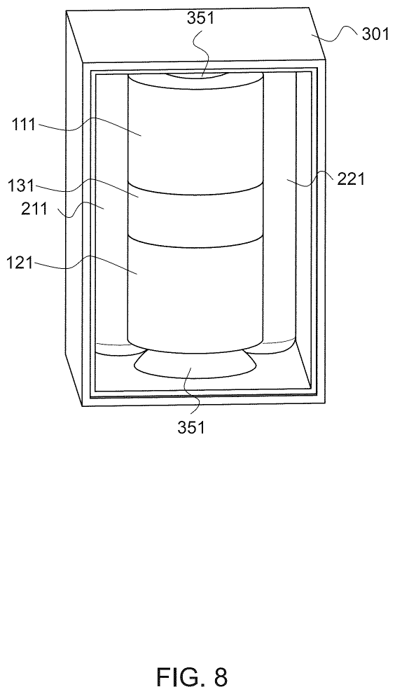

The box 301 has bumps 351 on either side of where the container is when the container rests on the rollers 211 and 221. Because the bumps have only a small area that might touch the container, it reduces the chance that the container will drag against the sides of the box. FIG. 8 shows how the bumps 351 help keep the container in place. In an alternative example, the bumps are more substantial and these structural bumps support the container.

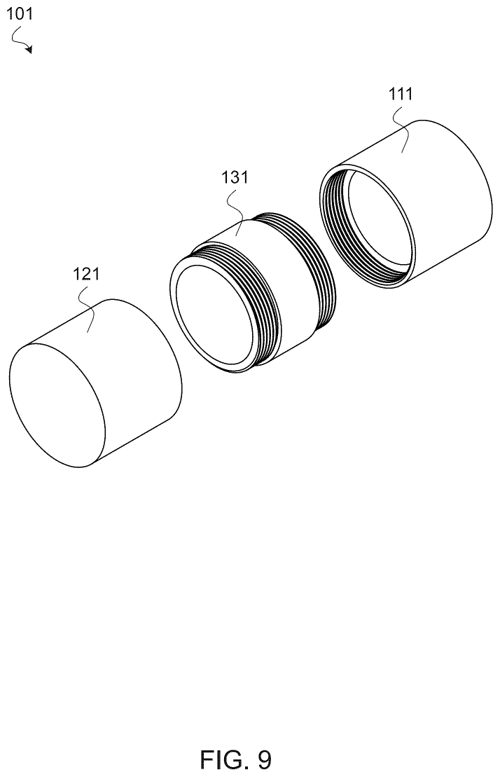

FIG. 9 shows how the container in this example, which is shaped like a cylinder 101 when put together (i.e., it is generally cylindrical), is made up of a top 111, a bottom 121, and a heating band 131. The pieces are threaded and go together without the need for any glue or tools; the pieces have threaded connections. Because the threads of the heating band are male threads, they extend inside the top part and the bottom part. This makes it easier and faster to transfer the heat from the heating band 131 to the interior of the assembled cylinder 101.

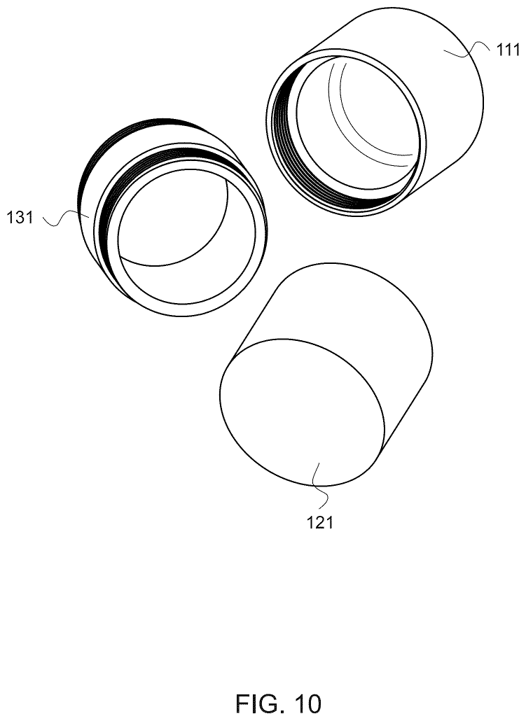

The heating band 131 shown in FIG. 10, when joined together with the other parts, forms a space that communicates between the space inside the top part and the space inside the bottom part. In one embodiment, the heating band has a separator in the middle to provide a container with two different areas to hold substances to be heated. The separator functions to define two chambers within the container.

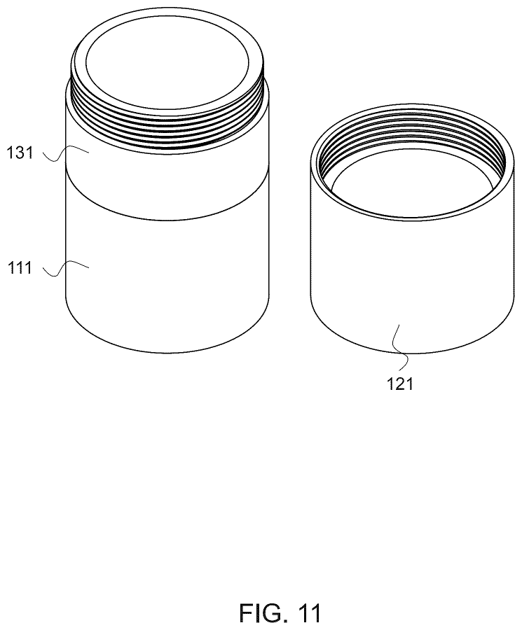

FIG. 11 shows how the user might assemble the top part to the heating band to form a cup. The user might then add the substance to be heated to the inside. Next, the user might assemble the bottom part to the rest. In the embodiment shown, there is no difference between the top part and the bottom part. In other embodiments, the bottom part might not be identical to the top part.

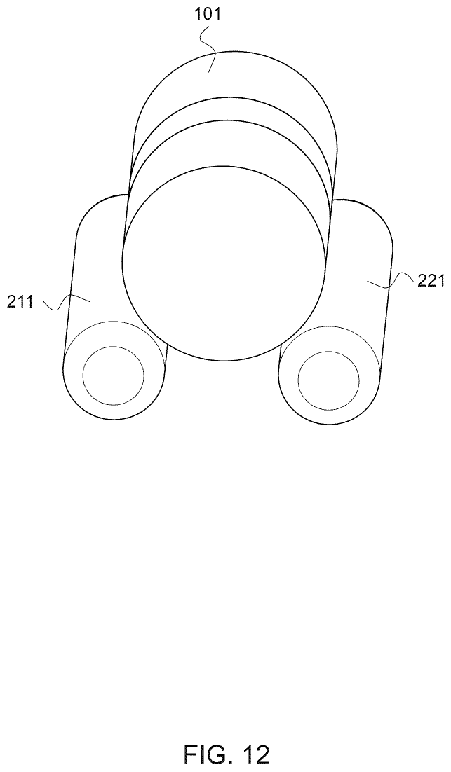

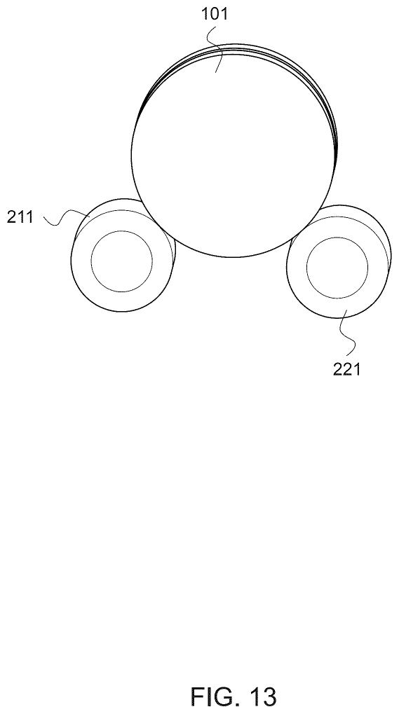

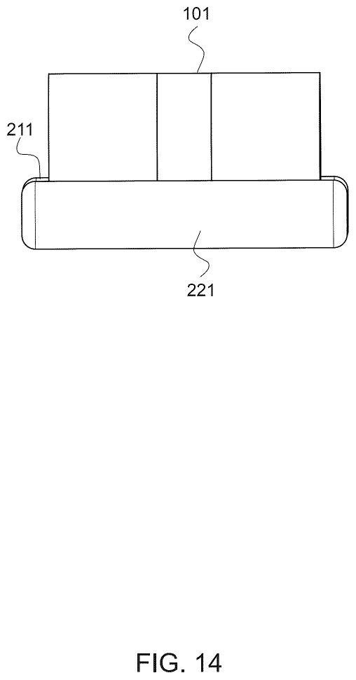

FIGS. 12-14 show the cylinder 101 resting on the rollers 211 and 221. These drawing figures depict the rollers as having rounded edges at their ends but do not depict how the rollers are rotated or how they connect to the box. The person familiar with this field will find numerous ways of arranging the rollers and determining how to engage them with the box. As mentioned above, any given roller may be powered or may freely spin.

Not all possible embodiments use rollers. The container may engage the box via axial projections that come out of the box, out of the top and bottom parts of the container, or other ways.

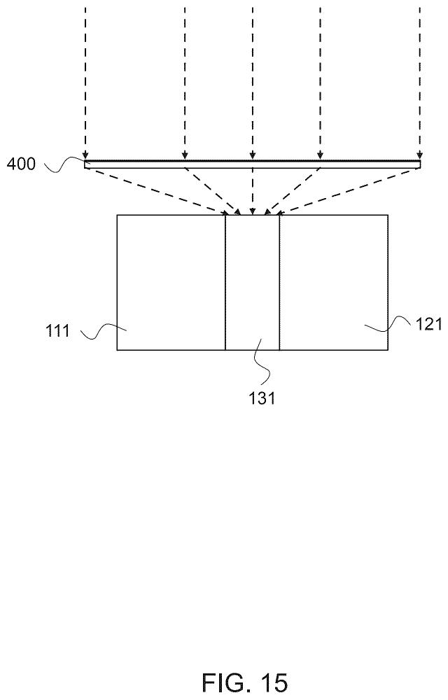

FIG. 15 shows, from the side, how rays of light pass through the lens 400. As they do, the lens focuses them onto the target area on the surface of heating band 131. In the embodiment where the lens is a Fresnel lens 400, the lens 400 is positioned above the container such that its focal point aligns with a specific target area on the heating band 130. The vertical distance between the lens and the heating band is selected based on the focal length of the lens. For example, if the Fresnel lens has a focal length of 30 mm, the top surface of the container should be placed approximately 30 mm beneath the lens to ensure optimal energy concentration. The lens may be mounted to the box lid using a frame or bracket that fixes the lens at the appropriate distance. In some embodiments, the lens mount is adjustable to allow tuning for different lens types or focal lengths. The focused sunlight strikes the heating band at a location that maximizes thermal transfer into the contents of the container.

Because the heating band is a conductor, it readily passes the heat to the interior of the container where the substance is. The substance warms. Because the top and bottom parts of the container are insulators (i.e., are made of insulating materials), they help keep the heat from leaving the container and help keep the substance from cooling down.

This discussion has revealed a number of embodiments, but not all of them. The scope of the invention should be gleaned by generalizing these teachings more broadly than the specific examples above.

Other features and other functions will occur to those familiar with this field and such variations are to be expected to follow in the light of the complete and detailed examples provided above. Such variations need not, however, be considered beyond the reach of the appended claim.

1. A solar warming apparatus, comprising:
a container with a heating band;
a box housing the container; and
a lens supported by the box and adapted to focus light rays onto the heating band.

2. The solar warming apparatus of claim 1, wherein the heating band is made of a thermally conductive material and the container comprises a top part and a bottom part made of insulating materials.

3. The solar warming apparatus of claim 2, wherein the heating band is made of aluminum.

4. The solar warming apparatus of claim 2, wherein the top part and the bottom part are made of double-wall stainless steel or ceramic.

5. The solar warming apparatus of claim 1, wherein the lens is a Fresnel lens.

6. The solar warming apparatus of claim 1, wherein the box is made of plexiglass.

7. The solar warming apparatus of claim 6, wherein the plexiglass includes a film to reduce glare.

8. The solar warming apparatus of claim 1, further comprising at least one roller supporting the container.

9. The solar warming apparatus of claim 8, wherein at least one roller is rotated by a motor.

10. The solar warming apparatus of claim 9, wherein the motor is powered by solar energy.

11. The solar warming apparatus of claim 8, wherein the container includes external teeth that engage with matching teeth on the at least one roller.

12. The solar warming apparatus of claim 8, further comprising a shaft connected to the container.

13. The solar warming apparatus of claim 8, further comprising a belt for rotating the container.

14. The solar warming apparatus of claim 8, wherein rotation is facilitated by magnets.

15. The solar warming apparatus of claim 1, wherein the container is cylindrical and comprises threaded connections between the heating band, a top part, and a bottom part.

16. The solar warming apparatus of claim 15, wherein the heating band includes a separator forming two chambers inside the container.

17. The solar warming apparatus of claim 1, wherein a width of the heating band corresponds to a focal area width of a focal area of the lens.

18. The solar warming apparatus of claim 1, wherein the container is rotatably supported by rollers in contact with the heating band.

19. The solar warming apparatus of claim 1, wherein the container rests in a position supported by structural bumps within the box.

20. The solar warming apparatus of claim 1, wherein the container is manually rotatable by a hand crank.
